(19) United States
(12) Patent Application Publication
(10) Pub. No.: US 2025/0382933 A1
(43) Pub. Date: Dec. 18, 2025

(54) High Pressure Fuel Pump For Use With DME And Other Liquified Gases

(71) Applicants: William de Ojeda, DARIEN, IL (US); Haibao Wu, Oakbrook Terrace, IL (US)

(72) Inventors: William de Ojeda, DARIEN, IL (US); Haibao Wu, Oakbrook Terrace, IL (US)

(21) Appl. No.: 18/741,030

(22) Filed: Jun. 12, 2024

(51) Int. Cl. F02M 37/06

(52) U.S. Cl. CPC F02M 37/06

(57) ABSTRACT

A high-pressure fuel pump for low-viscosity liquefied gases includes a plunger within a pump body and a seal surrounding the plunger to block fuel leakage into the crankcase. A communication passage connects the fuel side of the seal to the pump inlet, maintaining the seal at a substantially constant pressure near inlet supply pressure. In certain embodiments, the passage communicates with an annular groove positioned between the high-pressure chamber and the seal to isolate the seal from pressure pulsations and over-pressurization. This configuration improves seal durability, reduces leakage, and maintains separation between fuel and lubricating oil during high-pressure operation.

### CROSS-REFERENCE TO RELATED APPLICATIONS

The initial filing was submitted as a provisional application on Dec. 11, 2023. The same application was later filed as a Utility-Nonprovisional on Jun. 12, 2024. Formatting changes were made on Mar. 27, 2025 to start the abstract and claims on new sheets. This revision addresses the actions items noted by the patent examiner on the communication dated Jul. 14, 2025.

This invention was made with government support under contract DE-EE0009878 awarded by the Department of Energy. The government retains certain rights in the invention.

### BACKGROUND OF THE INVENTION

The invention enhances the performance of a high-pressure fuel pump. The pump includes a seal around the pump piston plunger to prevent fuel from entering the crankcase and features a recirculation path from the fuel side of the seal back to the pump inlet. The recirculation passage can be exposed to the seal or to an annulus groove in the pump housing bore placed along the plunger isolating the seal from the inlet pressure pulsations taking place during the pumping process.

Specifically, the invention aims to improve the operation of high-pressure fuel pumps designed for Diesel fuel, but cannot operate with fuels such as dimethyl ether (DME), propane, or similar liquefied gases. Leakage rates through the pumping plungers are significantly higher for liquefied gases than for Diesel due to their much lower viscosities. These leakage rates increase progressively as the pumping pressure rises. High-pressure fuel pumps used with liquefied gases are limited to relatively low pressures, lower than 500 bar, to reduce leakage. In comparison, many Diesel applications operate above 2000 bar. However, lower pressures hinder the ability to optimize combustion processes, as they limit the fuel's mixing with the charge air in the cylinder.

In addition, excess leakage rates passing through the plunger increase fuel-to-oil dilution, and increase erosion and wear, compromising the lubrication system of the pump over time.

### SUMMARY OF THE INVENTION

The invention relates to a high-pressure pump designed for use with liquefied gases that have significantly lower viscosity than Diesel fuel. These liquefied gases are supplied through a fuel delivery pump to the high-pressure pump at pressures above the saturation vapor point, ensuring the fuel remains in liquid form.

The invention features a plunger seal around the high-pressure pump plunger and a recirculation passage from the fuel side of the seal back to the intake of the high-pressure pump. The seal placement location in a high-pressure pump is optimized for both sealing performance and durability by maintaining a nearly constant pressure on its fuel side by means of the recirculation passage.

Previous art has attempted to contain the leakage rates in two ways.

First, patents U.S. Pat. Nos. 8,757,047B2, 10,280,884B2, and 11,261,853B2, disclose a design that includes a seal around the pump piston plunger. The seal prevents fuel from passing into the pump crankcase, but does not allow for controlling or limiting the pressure build-up near the seal on the pumping side. As the pumping piston plunger increases pressure, fuel will slip from the high-pressure volume into the seal. The pressure pulsations will gradually raise the static pressure at the seal over time. High pressures will weaken the function and lifespan of the seal, which depends on plunger speed, fluid viscosity, temperature, and pressure. Higher pressures require larger preload on the seal, leading to increased friction and operating temperatures. Under such conditions, seals would need to operate at lower speeds.

Secondly, patent US 2014/0109874 A1, discloses a system that allows high-pressure fuel to leak into the crankcase, which is later extracted to the tank or pump inlet. As a result, the crankcase is filled with lubrication oil and gaseous fuel. The patent also discloses a valve setup to return the oil and fuel gases to their respective sources. Consequently, the crank is not lubricated under pressure, limiting lubrication to only certain parts of the crankcase components. It also does not guarantee that some oil mist is returned with the gaseous fuel to the fuel circuit. Additional issues with this method include limitations caused by vehicle movement and problems with oil releveling and splashing.

U.S. Pat. No. 8,708,669 describes a mechanically driven fuel pump that uses a spring, not the cam drive, to perform the pressurizing stroke. The pump's piston moves between two chambers separated by a specially dimensioned seal, allowing bidirectional fuel flow through the inlet port without a check valve. During the cam-driven upstroke, fuel transfers from the first to the second chamber; during the spring-driven downstroke, fuel in the second chamber is pressurized and delivered through an outlet check valve. This design maintains a steady outlet pressure, reduces vapor lock risks, and eliminates inlet restrictions that can cause fuel boiling. U.S. Pat. No. 8,708,669 aims at maintaining constant moderate pressures for conventional liquid fuels, with its innovation centered on spring-driven pressurization, bidirectional inlet flow, and flexible-shaft remote mounting. The proposed patent application design extends sealing reliability and pressure management into a much higher pressure and lower-viscosity fuel regime, which U.S. Pat. No. 8,708,669 does not specifically address. While both inventions focus on controlling leakage, sealing, and pressure stability in reciprocating fuel pumps, the proposed patent application targets high-pressure operation with low-viscosity liquefied gases (e.g., DME, propane). It introduces a dedicated seal and recirculation passage to maintain constant pressure on the fuel side of the seal and fully separate fuel from lubricating oil, addressing leakage-induced wear and contamination at extreme pressures.

Therefore, the proposed patent application enables the pressure seal to operate reliably by keeping the fuel at the seal at a constant pressure, as supplied by the fuel delivery pump, in its liquid form. It also ensures a complete separation between the fuel and the lubricating oil.

### BRIEF DESCRIPTION OF THE DRAWINGS

An exemplary embodiment of the invention is illustrated in the drawings and described in more detail in the following explanation.

FIG. 1 provides an overview of the fuel system.

FIG. 2 shows an enlarged view of the fuel pump, including the body, plunger, seal, and recirculation passage.

FIG. 3 shows seal and recirculation passage and fluid gap.

FIG. 4 shows a secondary embodiment of the recirculation passage, wherein an annulus groove is used to isolate the seal from direct exposure to the inlet fluid and to the inlet flow pulsations.

FIG. 5 shows the flow leakage paths for the pump suction stroke (FIG. 5a) and for the pump pressurizing stroke (FIG. 5b).

### DETAILED DESCRIPTION

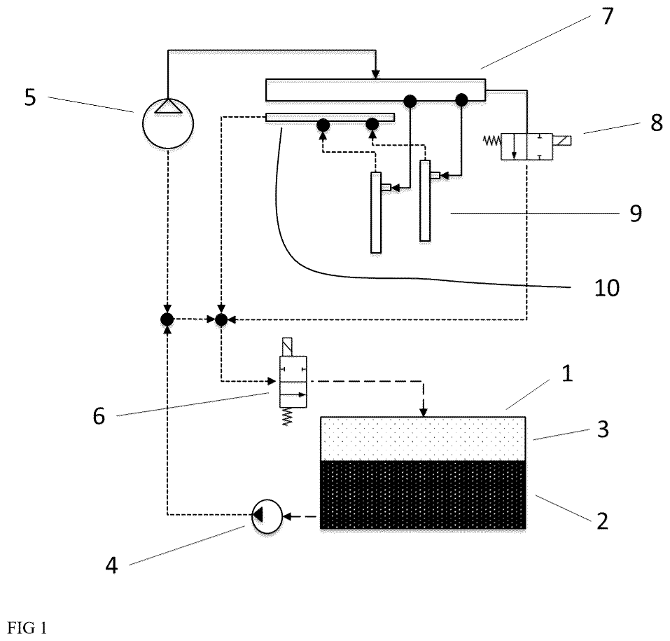

FIG. 1 shows a fuel system used with gaseous fuels that includes a supply tank (1). In the case of liquefied gases, the bottom part of the tank contains fuel in liquid form (2), while the upper part holds gases (3). It features a fuel delivery pump (4), a low-pressure regulator (6), a high-pressure fuel pump (5), a fuel rail (7), a fuel pressure regulator (8), and injectors (9), with the number of injectors varying depending on the engine cylinders.

The system also includes a fuel return passage (10) to collect excess fuel from the injector spill valves. The system is designed to supply high-pressure fuel to the injectors at pressures like those used in Diesel engines. This high pressure allows the combustion system to be optimized with short injection durations and efficient mixing in compression ignition applications. In this configuration, fuel always enters the high-pressure pump in liquid form, maintained by the fuel delivery pump (4) at a pressure above the fuel's saturated vapor point, assisted by the pressure regulator (6).

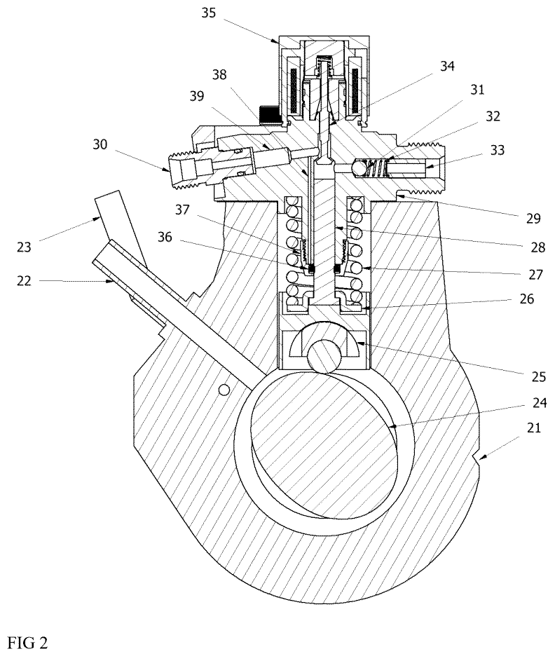

FIG. 2 provides a detailed view of the high-pressure pump (5) in the fuel system. The pump housing (21), with oil lubrication ports for inlet (22) and outlet (23), contains the pump crankshaft (24), which drives the pumping arrangement comprised of a roller-follower assembly (25), plunger return foot (26), the plunger return spring (27), and the pump plunger (28) which slides through the pump body (29). The plunger (28) and pump body (29) are deployed with a seal (36), retained by a cap (37) for dynamic sealing during the plunger (28) reciprocating motion. Additionally, the pump body (29) features a recirculation passage (38) that directs fuel leakage through the plunger and body (28-29) to the pump inlet (39) which communicates with the fuel supply fitting (30). The seal (36) prevents fuel from entering the pump's crankcase, which contains components such as the crankshaft (24) and roller-follower (25) that are oil-lubricated. Fuel flows through the inlet passage (39), with flow controlled by the metering valve (34), operated by the solenoid actuator (35). Fuel pressure increases as the pump plunger moves upward and the inlet valve (34) closes. The timing of this closure regulates fuel flow and pressure. The output exits through the check valve (31), which is spring loaded (32), into the outlet passage (33). In other pump design embodiments, the metering valve (34) may be simply spring-loaded, with high pressure regulated by the fuel pressure regulator (8), which is located in or near the fuel rail (7) as illustrated in FIG. 1.

Without the fuel recirculation passage (38), the seal (36) is exposed to fuel pressures that depend on the pressures generated by the high-pressure pump plunger (28). Higher pumping pressures lead to increased leakage through the gap between the plunger (28) and body (29). The plunger seal (36), which operates at high speed due to the reciprocating motion of the crank, will be compromised by the high pressures caused due to the leakage. With the recirculation passage (38), the seal is subjected to a steady pressure maintained by the fuel pressure from the delivery fuel pump (4).

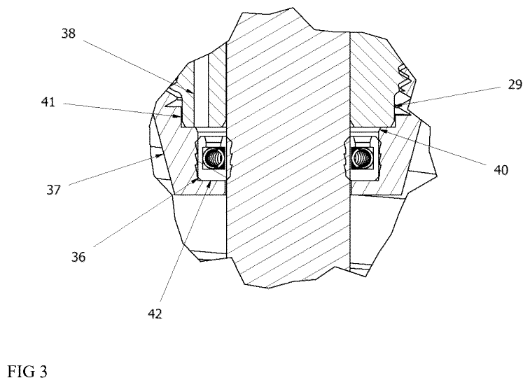

FIG. 3 shows a detail of the seal (36) placement within the cap (37) with a shoulder feature (41) aiding to position the seal concentrically in relation to the pump body (29). The figure illustrates the recirculation passage (38) communicating with the seal (36) through a gap (40), allowing fluid to be evenly exposed to the seal surface, and helping it to sit against the cap mating surface (42).

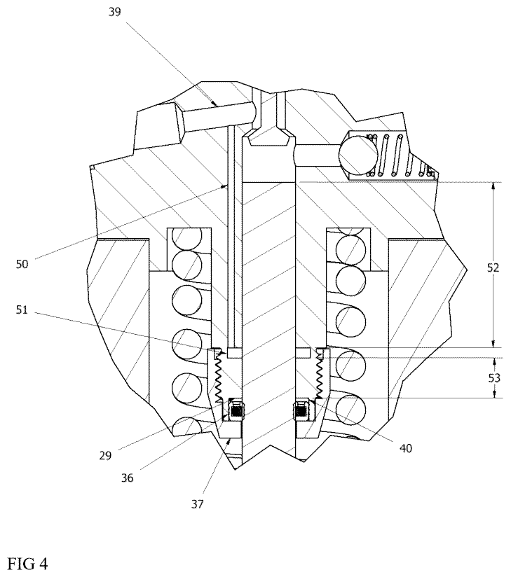

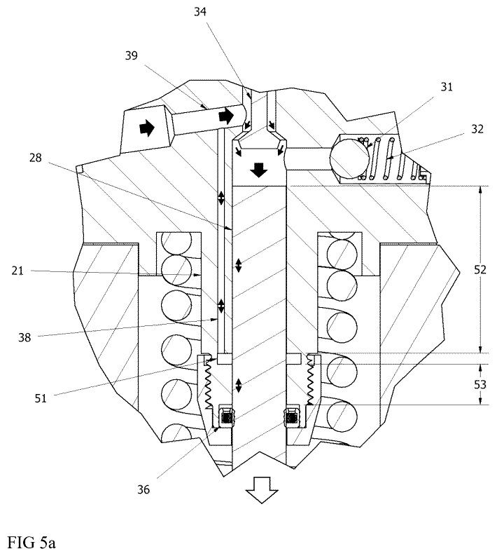

FIG. 4 shows an alternative embodiment of the seal and recirculating passage. In this rendering the seal (36) is contained in the pump body (29), improving the seal concentricity with respect to the embodiment of FIG. 3 which was dependent on the cap (37). In this rendering, the recirculation passage (50) connects to an annulus groove in the pump body (51). The engagement length (52), along with fluid properties, plunger-to-body bore clearance, and pressure differential, determines the leakage rate. The annulus groove (51) collects leakage flow from the high-pressure volume and directs it to the inlet passage (39). The seal is further isolated from the high-pressure side with a tight clearance engagement (53), same as that of (52). The optimal ratio between (52) and (53) is greater than 50/50 and less than 90/10. Leakage through the passage (53) is collected at the gap (40), allowing the pressure to be uniform against the seal.

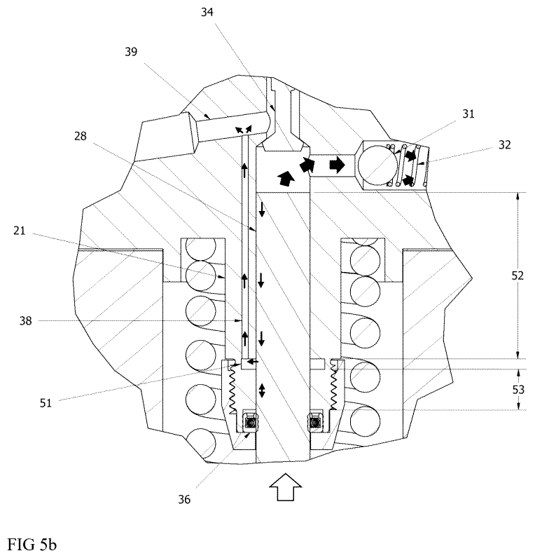

FIG. 5a shows the pump operation during the intake stroke. The plunger (28) moves downward as noted by the white arrow. Flow, indicated by dark arrows, is induced through the body inlet passage (39) and inlet valve (34). The pressure above the plunger (28) is slightly lower than the inlet pressure due to the volume expansion, and lower than the pressure at the outlet, so that the pressure differential across the ball (31) assisted by the spring (32), forces the outlet check ball (31) to be in the closed position. With pressure above the plunger (28) near the inlet pressure, the leakage flow between the plunger (28) and the pump body (21) along the length (52) is negligible. Likewise flow along (53) is also negligible. In this embodiment the flow from the groove (51), along the recirculating passage (38) is also negligible.

FIG. 5b shows the pump operation during the pumping stroke. The plunger (28) moves upward as noted by the white arrow. Flow, indicated by dark arrows, exits the high-pressure volume above the plunger (28), through the ball (31), when the pressure exceeds the pressure of the outlet and overcomes the spring (32) force. During the pumping stroke the inlet valve (34) is closed. The high pressure above the plunger (28) creates a differential pressure across distance (52), and fluid flows from the top of the plunger to the annulus grove (51), at a rate determined by the clearance gap between the plunger (28) and the pump body (21) bore, the engagement distance (52), the pressure differential, and the fluid properties. The leakage flow is directed via the recirculation passage (38) to the inlet passage (39). The flow along overlap (53) is negligible because of the seal (36), which prevents leakage flow to pass out from the fuel side to the crank case of the pump. Pressure above seal (36) remains at the inlet pressure.

What is claimed is:

1. A fluid pumping device designed for use in a high-pressure fluid system, operating between 200 bar 3000 bar pressure, and comprising:
a device body with a cavity and a high-pressure circuit;
a plunger placed in the specified cavity designed for reciprocal motion;
a cap at the end of the device body;
a seal installed with its outer diameter fitted with a preset interference into the device body and its inner diameter fitted around the plunger diameter or alternately its outer diameter fitted with a preset interference into a cap attached to the body; and, a communication passage extending from the supply pressure port of the control device to the fuel side of the seal;
wherein the leakage rate between the device body and the plunger depends on the cylindrical gap between these parts, the engagement length, the fluid's viscosity, and the pressure difference between the high pressure generated by the plunger and the fluid pressure at the seal;
wherein the seal determines the leakage rate from the fluid control device based on the interference fit between the seal's outer diameter and the control device body, as well as the interference fit between the seal's inner diameter and the plunger.

2. The fluid control device of claim 1, wherein the pressure on the fuel side of the seal remains almost constant at a pressure near the inlet supply pressure due to the described communication passage.

3. The fluid control device of claim 1, wherein the seal is positioned inside the control device, in a cavity bored concentrically to the plunger cavity.

4. The fluid control device of claim 1, wherein the seal is secured by the seal cap, which attaches to the device body via a threaded connection or a press fit, keeping it stationary with respect to the seal cap.

5. The fluid control device of claim 1, wherein a gap exists between the control device body and the fuel side of the seal after the cap has been installed.

6. The fluid control device of claim 1, wherein the seal remains stationary with respect to the seal cap due to the press fit between the seal outer diameter and the device body seal bore, supported by the communication passage that creates a positive pressure differential between the fuel side of the seal and the crank side of the seal.

7. A fluid control device designed for use in a high-pressure fluid system, operating between 200 bar 3000 bar pressure, comprising:
a device body with a cavity and a high-pressure circuit;
a plunger placed in the specified cavity, designed for reciprocal motion;
a cap positioned at the end of the device body;
a seal installed with its outer diameter fitted with a preset interference into the device body and its inner diameter around the plunger diameter or alternately its outer diameter fitted with a preset interference into a cap attached to the body;
an annulus passage in the fluid control device body surrounding the plunger cavity positioned between the high-pressure volume and the seal; and,
a communication passage extending from the supply pressure port of the control device into the annulus passage;
wherein the fuel pressure inside the annulus passage stays nearly constant at a level close to the inlet pressure due to the communication passage;
wherein the leakage rate between the device body and the plunger depends on the cylindrical gap, engagement length, fluid viscosity, and the pressure difference between the high pressure generated by the plunger and the pressure in the annulus passage;
wherein there is an additional engagement between the fluid control device body and the plunger extending from the annulus passage to the seal.

8. The fluid control device of claim 7, wherein the control device body includes an annulus passage along the plunger bore, positioned so that the ratio between the distance from the annulus passage to the high-pressure volume at the end of the plunger and the distance from the annulus passage to the seal cavity is greater than 50-50 and less than 90-10.

9. The fluid control device of claim 7, wherein the clearance between the control device body and the plunger bore remains consistent from the annulus passage leading to the high-pressure volume at the end of the plunger and from the annulus passage to the seal cavity.
